(19) United States
(12) Patent Application Publication
(10) Pub. No.: US 2026/0245996 A1
(43) Pub. Date: Aug. 20, 2026

(54) Method for Determining the Ageing of a Single Battery Cell

(71) Applicant: Mercedes-Benz Group AG, Stuttgart (DE)

(72) Inventors: Hendrik PEGEL, Stuttgart (DE); Otto VON KESSEL, Stuttgart (DE)

(21) Appl. No.: 19/164,769

(22) PCT Filed: Feb. 8, 2024
(86) PCT No.: PCT/EP2024/053262

§ 371 Date: Sep. 12, 2025

(30) Foreign Application Priority Data
Mar. 15, 2023 (DE) 10 2023 001 008.1

(51) Int. Cl. H01M 10/44; G01B 21/08; H01M 4/02; H01M 4/38; H01M 4/505; H01M 4/525; H01M 4/583; H01M 10/0525; H01M 10/42

(52) U.S. Cl. CPC H01M 10/441; G01B 21/08; H01M 10/4285; H01M 2004/027; H01M 2004/028; H01M 4/386; H01M 4/505; H01M 4/525; H01M 4/583; H01M 10/0525

(57) ABSTRACT

A method for determining an ageing of a single battery cell in a lithium-ion battery composed of a plurality of single battery cells includes recording a cell thickness change of the single battery cell over a charging state and evaluating a curve of the cell thickness change over the charging state during charging and discharging of the single battery cell. The evaluating includes determining a silicon ageing by evaluating a plateau hysteresis of the cell thickness change between a charging plateau and a discharge plateau of the curve, determining a graphite ageing by evaluating a height of the discharge plateau, and/or determining a manganese-nickel-cobalt ageing by evaluating a maximum of the cell thickness change over the charging state.

### BACKGROUND AND SUMMARY OF THE INVENTION

The invention relates to a method for determining the ageing of a single battery cell.

It is generally known from the prior art that single battery cells, and this applies in particular to lithium-ion cells, experience an increase or decrease in volume with increasing charge and/or discharge. Moreover, it is such that the volume also changes with age as a single battery cell ages.

DE 10 2021 005 418 A1 now takes up this idea in order to determine the ageing state of a single battery cell using a method based on cell thickness. Here, the change in cell thickness of a single battery cell is recorded over the charging state and then divided into the portion caused by charging or discharging, on the one hand, and the portion caused by the ageing of the single battery cell, on the other hand. This allows conclusions to be drawn about the ageing of the single battery cell.

Here, it is such that the ageing-related change in cell thickness has different effects on different materials. The publication “Volume and thickness change of NMC811|SiOₓ-graphite large-format lithium-ion cells: from pouch cell to active material level” by Hendrik Pegel et al. in the Journal of Power Sources 537 (2022) 231443 illustrates the relationships involved here. Essentially, the result is that the total cell thickness change over a charge and discharge cycle of the single battery cell is here partly composed of the cell thickness change caused by the silicon and graphite (anode side) on the one hand, and the manganese-nickel-cobalt material (cathode side), referred to as NMC, on the other hand. The total cell thickness change is thus the sum of the cathode ageing on the one hand and the anode ageing on the other hand.

In this context, reference can furthermore be made to LOUL[, A. J. [et a].]: Volume, pressure and thickness evolution of Li-lon pouch cells with silicon-composite negative electrodes. In: Journal of the Electrochemical Society, Vol 2017. No. 12. p. A2689-A2696.—ISSN 1945-7111. Dol: 1O.1149/2.1691712jes.

Regarding the general prior art, reference can furthermore be made to US 2016/0 116 548 A1, which deals with the thickness measurement of battery cells, and US 2019/0 178 944 A1.

The object of the present invention is now to create a method for determining the ageing of a single battery cell that is improved compared to the prior art and in which conclusions can be drawn about the ageing caused by the respective active material.

Similar to the prior art mentioned above, the cell thickness change of the single battery cell as a whole is here correspondingly recorded. This cell thickness change over the charging state, in particular over a charge and discharge cycle of the single battery cell, then results in a corresponding curve of the cell thickness change. This is then evaluated for each single battery cell to determine, based on characteristic properties, the contribution of at least one of the active materials to the cell thickness change and thus ultimately to the ageing of this specific active material. The characteristic properties that the individual active materials inherently have on the cell thickness change are known in principle from the scientific publication. These characteristic properties are now used in order to infer the contribution of the respective active material used to this cell thickness change from a recorded age-related cell thickness change. This ultimately makes it possible to ascertain the ageing of this specific active material, i.e., for example the removal of graphite or silicon in the anode region or the loss of active material in the cathode region, for example through plating processes or the like.

This makes it possible to specifically exclude or adjust those operating conditions when controlling the battery which have a particularly strong impact on the ageing of one or the other active material. This makes it possible to effectively halt the progression of ageing processes.

Moreover, the method allows for the breakdown of the influence of the individual active materials on this cell thickness change by simply measuring the cell thickness change. This makes it comparatively easy to collect data under real operating conditions in a fleet of electric or hybrid vehicles, which can be used to further develop the understanding of the ageing processes of such individual battery cells.

In principle, the analysis of the curve carried out according to the invention for characteristic properties of at least one active material can be used to determine its contribution to the cell thickness change occurring over the lifetime of the single battery cell. According to a very advantageous development, it is here provided that this is correspondingly carried out for all active materials, i.e., for example silicon, graphite, NMC, lithium metal, and lithium iron phosphate, wherein a linear relationship between the volumetric portion of the respective active material and its influence on the cell thickness change is assumed.

For this purpose, according to the invention, to determine silicon ageing, a plateau hysteresis of the cell thickness change between a charging plateau and a discharging plateau is evaluated. The curve of the cell thickness change of the entire single battery cell will always have a characteristic plateau during charging on the one hand and a characteristic plateau lying above it during discharging on the other hand. The distance between these two plateaus is referred to here as the plateau hysteresis. This plateau hysteresis can now be evaluated in order to infer from the measured cell thickness change of the entire single battery cell the portion of this cell thickness change caused by the silicon. In particular, it has been shown that the plateau hysteresis is significantly greater at the beginning of the life of a single battery cell than when this single battery cell has already aged. The silicon ageing can thus be derived from the size of the plateau hysteresis. Studies have shown that silicon ageing, which is determined by means of the plateau hysteresis in the characteristic curve of the cell thickness change for silicon, corresponds to that which is determined by the curve of the cell thickness change of the full cell. Silicon ageing can thus be correspondingly determined by means of the two thickness values of the first and second plateaus, which are related to each other.

For this purpose, according to the invention, a height of the discharge plateau of the cell thickness change is evaluated to determine the graphite ageing. Here, it is also the case that the height of the discharge plateau corresponds to the cell thickness change caused by the ageing of the graphite. In particular when silicon ageing is already known and thus the silicon contribution to the cell thickness change of the discharge plateau is known, the graphite-related contribution to the height of the discharge plateau can thus be easily deduced from the difference, such that the graphite ageing can be correspondingly calculated from this. When silicon ageing is known, the NMC ageing plays virtually no role in the region of the second discharge plateau, such that its contribution can here be neglected without loss of accuracy.

According to the invention, to determine the NMC ageing, the maximum of the cell thickness change over the discharge state can then be evaluated. Typically, this maximum will be in the range of a fully charged cell, i.e., a state of charge of 100%. A maximum occurring in this range then allows inferences to be drawn about the characteristic minimum in the cell thickness change caused by NMC that typically occurs in this range. With known values for the silicon and graphite ageing, the NMC ageing can be easily determined.

According to a very advantageous development of the invention, it is thus provided that the silicon ageing, then the graphite ageing, and finally the NMC ageing are determined by means of the cell thickness changes characteristic of the respective active material. This has the advantage that the known plateau height in the cell thickness change which has been caused by the silicon can already be included in the determination of the graphite ageing, and that the other two values can already be taken into consideration in determining the absolute value of the minimum in the NMC-induced cell thickness change.

In order to now be able to determine this across relevant parts and in particular the entire state of charge, it is proposed according to a very advantageous development of the method according to the invention that a value of the silicon-induced cell thickness change over the charging state, determined from the plateau hysteresis, is used in order to compress a known starting curve of the silicon-induced cell thickness change at the beginning of the life cycle over the charging state in the direction of the cell thickness change in order to obtain an age-appropriate curve of the silicon-induced cell thickness change over the entire charging state during charging and discharging. The measured value of the plateau hysteresis also allows conclusions to be drawn about the cell thickness changes that occurred in the respective plateau and thus makes it possible to correspondingly determine the height of the plateau in the curve. From this, starting from a known curve of the silicon-induced cell thickness change at the beginning of a life of a cell, a current curve of the silicon-induced cell thickness change can be calculated by compressing this curve by means of the ascertained values. This current curve indicates the value of the silicon-induced cell thickness change in the current ageing state of the battery cell over the entire range of charging and discharging. This curve can then be correspondingly subtracted from the measured overall curve in order to obtain the proportion of the graphite- and NMC-induced cell thickness change in the current ageing state. In order to determine this, characteristic ranges for the respective material are used, in particular in the sense described above for determining the graphite-induced cell thickness change and thus ultimately the graphite ageing, the height of the final charge plateau.

Analogous to the use of the value recorded from the plateau hysteresis for the silicon-related cell thickness change, a known curve at the beginning of the life of the single battery cell can now be correspondingly compressed for the proportion of the graphite-related cell thickness change from the height of the discharge plateau in the graphite-related cell thickness change, in order to thus obtain not only the age-appropriate silicon-related cell thickness change but also the age-appropriate graphite-related cell thickness change as a new curve in the current ageing state of the single battery cell.

In particular, these two curves can then be used to determine the proportion of the cell thickness change of the entire cell caused exclusively by the NMC, in order to thus easily and efficiently identify the peak in the minimum of the NMC curve and, from its size, to determine the NMC-related cell thickness change and thus the ageing state of the NMC, substantially the cathode.

Specifically, according to an advantageous design, the cell thickness difference between a charging plateau of the curve of the cell thickness change over the charging state and a discharge plateau of this curve can be evaluated to determine silicon ageing. A decreasing distance between the plateaus, i.e., a decreasing plateau hysteresis, here indicates greater silicon ageing.

According to an advantageous development, to determine the graphite ageing, a graphite-related height of the discharge plateau can be ascertained from the difference between the recorded height from the curve of the cell thickness change of the full single battery cell and the previously ascertained silicon-related height change of the discharge plateau. As the size or height of the graphite-related cell thickness change of the discharge plateau decreases, then greater graphite ageing is then inferred. Furthermore, using the two already ascertained ageing values, it can then be provided that the respective maxima of the cell thickness change, which are caused by silicon and graphite, are ascertained during full charge, and that the minimum of the cell thickness change due to NMC occurring during full charge is ascertained from the difference between the overall maximum and the graphite- and silicon-related maxima, wherein as the absolute value of the minimum becomes smaller, an increasing NMC ageing is concluded.

Simply by evaluating the corresponding characteristics in the curve, it is thus possible to easily and efficiently ascertain a breakdown of the ageing-related cell thickness change among the various active materials involved, i.e., their influence on the respective absolute value of the cell thickness change. As already mentioned above, this can be used to improve the control or operating strategy for such a battery, as well as for comprehensive data collection in order to be able to better analyse and understand ageing processes in such single battery cells.

The method according to the invention is subsequently explained in detail by means of an exemplary embodiment, for which reference is made to the figures.

### BRIEF DESCRIPTION OF THE DRAWINGS

FIG. 1 is a diagram of the applied methodology with the method according to the invention;

FIG. 2 is a schematic depiction of the percentage expansion of the single battery cell in percent over the charging state, wherein curves for the entire cell, the anode, substantially made of silicon and graphite, and the cathode made of NMC are shown;

FIG. 3 shows two curves of the percentage expansion in percent of the cell thickness, i.e., the cell thickness change over the charging state, once at the beginning of the life of a single battery cell (a) and in an aged state (b);

FIG. 4 shows the silicon-related portion of the cell thickness change according to FIG. 3;

FIG. 5 shows the graphite-related portion of the cell thickness change analogous to FIGS. 3 and 4; and

FIG. 6 shows the NMC-related portion of the cell thickness change analogous to or in addition to FIGS. 3, 4 and 5.

### DETAILED DESCRIPTION OF THE DRAWINGS

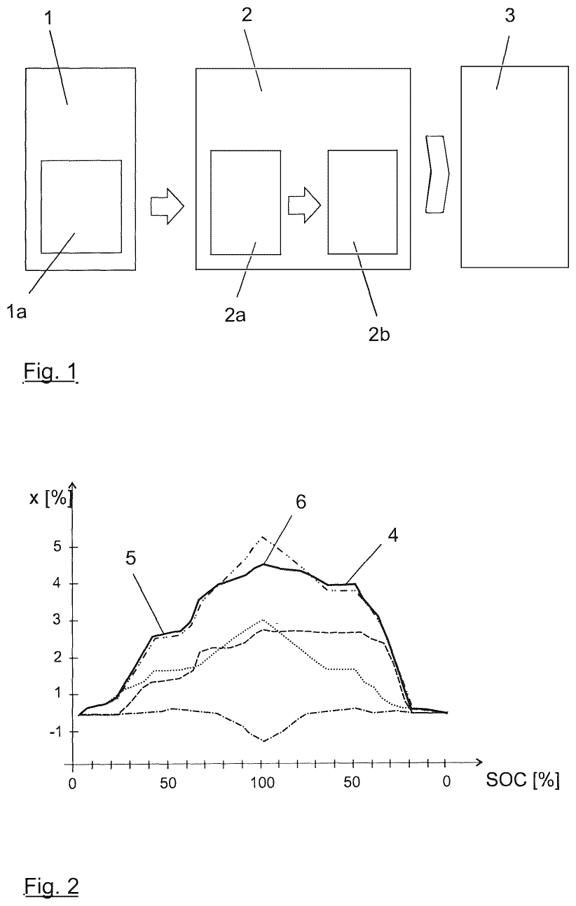

In the depiction of FIG. 1, the methodology of the method presented here is described in a flowchart. The first block, labelled 1 and depicted on the far left, describes the in-operando measurement in a vehicle, wherein in this measurement, the change in the expansion of a single battery cell as a function of the charging state is recorded. This is also referred to below as cell thickness change and substantially represents the percentage change in the thickness of the single battery cell over the charging state, starting from an empty single battery cell to full charge and then to the next final discharge.

The middle block of the diagram in FIG. 2, which is designated here by 2, substantially describes a battery control device 2. Based on the in-operando measurement 1 in the vehicle, the measured cell thickness change over the charging state is then transmitted to this battery control device 2. In a first block 2a, the theoretical knowledge about the distribution of the cell thickness change among its portions determined by the respective active material is then applied in order to establish a relationship between the cell thickness change and the ageing of the active materials over the ageing of the single battery cell. This is symbolized by the block labelled with 2b. The corresponding target information 3 is then further used, either in the battery control device itself in order to adapt the control in such a way that the ageing effects are minimized, or also in order to collect data that here helps to better understand the ageing process.

In the depiction of FIG. 2, the percentage expansion of the thickness of the cell, referred to below as the cell thickness change, is depicted as a percentage of the charging state. This curve represents the initial state of a single battery cell at the beginning of its life. The cell thickness change here varies between −1% and c. +5.5%. The charging state has full charge in the middle, such that discharging is shown to the left of the middle and charging is shown to the right of the middle. In other words, charging takes place to the left of the middle, hence on the x-axis from 0% to 100% SOC is in the middle, and then discharging to the right of the middle, from 100% SOC to 0% SOC. The in-operando measured cell thickness change is indicated by the solid bold curve. Its division into the individual portions is firstly carried out into the cathode portion, which is depicted with a dash-dotted line, and the anode portion, which is shown with a dash-two-dotted line. The portion of the cathode-related cell thickness change x over the charging state (SOC) here substantially corresponds directly to the NMC-related ageing, since this is the main material of the cathode. The anode-related cell thickness change is in turn divided into the two active materials of the anode: silicon on the one hand and graphite on the other hand. The silicon-related cell thickness change is depicted with a dashed line, the graphite-related cell thickness change with a dotted line. This is also maintained in the following figures, wherein a repeated depiction of the anode-related cell thickness change, which is in fact only the sum of the silicon-related and graphite-related cell thickness change, will be omitted below.

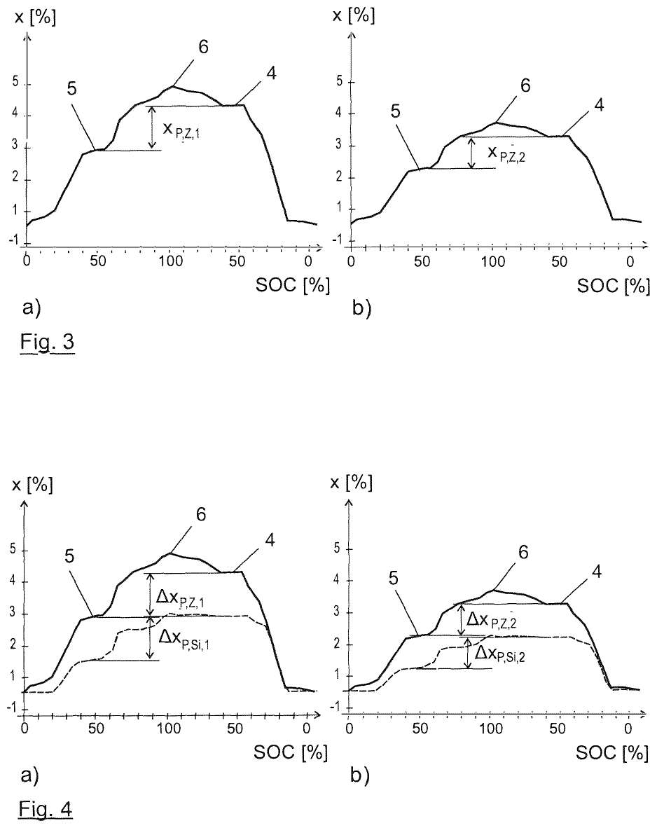

As already mentioned, during in-operando measurement 1 in the vehicle, in the block labelled 1, the cell thickness change x is measured over the charging state SOC. In the depiction in FIG. 3a, this is shown again in the diagram alone, analogous to the depiction in FIG. 2. The state in the diagram in FIG. 3a here depicts the state of the cell thickness change at the beginning of the life of the single battery cell. In addition, in FIG. 3b, substantially the same curve, i.e., the cell thickness change x of the entire cell, is shown at a later point in time, with increased ageing of the single battery cell. The respective curve here indicates an unknown superposition of the portions of the individual active materials in the respective ageing state (a), b)).

Here, this curve also already shows some characteristic elements, such as a discharge plateau labelled with 4, for example, and a charging plateau labelled with 5 and a maximum labelled with 6, which can be seen as characteristic points or regions of the curve both in FIG. 3a, at the beginning of the life of the single battery cell, and in FIG. 3b, i.e., in an already aged single battery cell.

The difference between the discharge plateau 4 and the charging plateau 5 is indicated in FIG. 3a as Δ_{xP,Z,1}. For the cell thickness change x of the aged single battery cell, this difference between the charging plateau 5 and the discharge plateau 4 is also shown and labelled with Δ_{xP,Z,2}. The plateau hysteresis, i.e., the distance between the discharge plateau 4 and the charging plateau 5 in the direction of the cell thickness change, has noticeably decreased.

In the depiction in FIG. 4a and in FIG. 4b, the curve for the portion of silicon-related ageing is correspondingly plotted at the start of the life cycle of the single battery cell in FIG. 4a and in the aged single battery cell in FIG. 4b. The silicon-related ageing itself, which is often denoted by ϑ_{Si}, can thus be ascertained from the ratio of the current plateau hysteresis Δ_{xP,Z,2} and the plateau hysteresis for the new single battery cell Δ_{xP,Z,1}, wherein this value, multiplied by 100, results in the percentage value for the silicon ageing or a degree of silicon ageing. In FIGS. 4a, b, it can now be seen that the plateau hysteresis Δ_{xP,Z,1}, Δ_{xP,Z,2} ascertained by means of the cell thickness change of the single battery cell correspond to those in the silicon curve Δ_{xP,Si,1}, Δ_{xP,Si,2}. This gives:

$${ϑ}_{Si} = \frac{Δ {x}_{P , Si , 2}}{Δ {x}_{P , Si , 1}} \cdot 100 = \frac{Δ {x}_{P , Z , 2}}{Δ {x}_{P , Z , 1 , 1}} \cdot 100$$

This correspondence now makes it possible to derive the entire curve from the silicon portion of the cell thickness change known from FIG. 2 by compression in the direction of the cell thickness change.

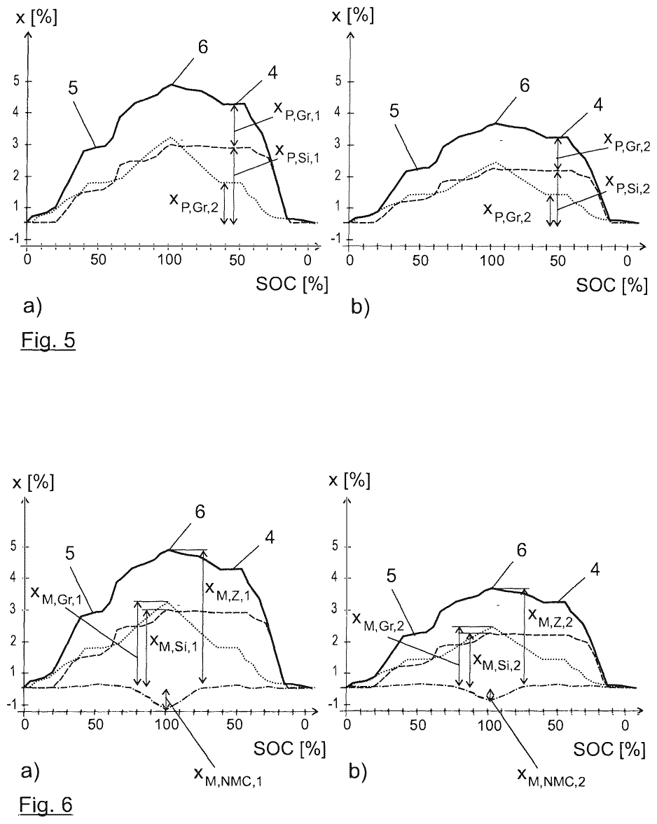

Analogous to the previous depiction, FIGS. 5a and 5b now address graphite-induced ageing. Characteristic of graphite-induced ageing or the graphite-induced change in cell thickness x is the level of the discharge plateaus 4 above the zero line of cell thickness change. The height x_{P,Ent,2} of the discharge plateau 4 of the solidly depicted overall curve is thus composed of the addition of the graphite-induced height x_{P,Gr,2} of the discharge plateaus 4 and the silicon-induced height x_{P,Gr,1} of the discharge plateau 4.

$${x}_{P , Ent , 2} = {x}_{P , Si , 2} + {x}_{P , Gr , 2} +$$

Here, theoretically, the NMC-induced cell thickness change x_{P,NMC,2} of the cathode also plays a minimal role. However, in practice, this is so small that it can be completely neglected in the region of the discharge plateau 4.

With a known silicon-related height of the discharge plateau 4 from the relationship described in the scope of FIG. 4, the graphite-related plateau height x_{P,Gr,2} can now be mathematically ascertained.

$${x}_{P , Gr , 2} = {x}_{P , Ent , 2} + {x}_{P , Si , 2}$$

The graphite ageing ϑ_{Gr} can then be derived again from the plateau height x_{P,Gr,2} of the aged cell in relation to the plateau height x_{P,Gr,1} of the cell at the beginning of its life and correspondingly multiplied by 100 as a percentage value.

$${ϑ}_{Gr} = \frac{{x}_{P , Gr , 2}}{{x}_{P , Gr , 1}} \cdot 100$$

Similar to before with the curve for the corresponding ageing state of the single battery cell for silicon, the initial curve known fundamentally from FIG. 2 can now also be compressed for graphite corresponding to the recorded values of the final discharge plateau, such that, ultimately, in addition to the curve of the cell thickness change of the single battery cell, the silicon and graphite-related cell thickness changes, shown here again as dashed and dotted lines, can also be entered.

As can also be seen from the depiction in FIG. 2, a characteristic point for ascertaining the NMC-related cell thickness change x and thus the NMC ageing ϑ_{NMC} is the minimum in the range of 100% SOC.

The known maxima of the silicon-induced cell thickness changes and, above all, the graphite-induced cell thickness changes can here be correspondingly offset. The total maximum x_{M,Z,2} in FIG. 6b is thus composed of the sum,

$${x}_{M , Z , 2} = {x}_{M , Si , 2} + {x}_{M , Gr , 2} + {x}_{M , NMC , 2}$$

such that x_{M,NMC,2} can ultimately be calculated by the difference between the maximum for the full cell and the two silicon- and graphite-induced maxima being ascertained.

$${x}_{M , NMC , 2} = {x}_{M , Z , 2} - {x}_{M , Si , 2} - {x}_{M , Gr , 2}$$

The following then applies for the NMC-related ageing:

$${ϑ}_{NMC} = \frac{{x}_{M , NMC , 2}}{{x}_{M , NMC , 1}} \cdot 100$$

Here again, it is such that an increasing ageing of the NMC or the cathode is present with a reduced absolute value of the minimum.

1.-11. (canceled)

12. A method for determining an ageing of a single battery cell in a lithium-ion battery composed of a plurality of single battery cells, comprising the steps of:
recording a cell thickness change (x) of the single battery cell over a charging state (SOC); and
evaluating a curve of the cell thickness change (x) over the charging state (SOC) during charging and discharging of the single battery cell;
wherein the evaluating includes:
determining a silicon ageing (ϑ_{Si}) by evaluating a plateau hysteresis (Δx_{P}) of the cell thickness change (x) between a charging plateau (5) and a discharge plateau (4) of the curve; and/or
determining a graphite ageing (ϑ_{Gr}) by evaluating a height (x_{P}) of the discharge plateau (4); and/or
determining a manganese-nickel-cobalt (NMC) ageing (ε_{NMC}) by evaluating a maximum (x_{M}) of the cell thickness change (x) over the charging state (SOC).

13. The method according to claim 12, wherein a linear relationship between a volumetric portion of silicon (Si), graphite (Gr), and (NMC) and its influence on the cell thickness change (x) is assumed.

14. The method according to claim 12, wherein first the silicon ageing (ϑ_{Si}) is evaluated, then the graphite ageing (ϑ_{Gr}) is evaluated, and finally the NMC ageing (ϑ_{NMC}) is evaluated.

15. The method according to claim 12, wherein at least one value ascertained from the plateau hysteresis (Δx_{P}) is used in order to compress a known initial curve of a silicon-related cell thickness change (x) over the charging state (SOC) in a direction of the cell thickness change (x) in order to obtain a curve of the cell thickness change (x) corresponding to a current ageing over an entire charging state (SOC) during charging and discharging.

16. The method according to claim 15, wherein at least one value ascertained from the height (x_{P}) of the discharge plateau (4) is used in order to compress a known initial curve of a graphite-induced cell thickness change (x) over the charging state (SOC) in the direction of the cell thickness change (x) in order to obtain the curve of the cell thickness change (x) corresponding to the current ageing over the entire charging state (SOC) during charging and discharging.

17. The method according to claim 12, wherein a reduction in the plateau hysteresis (Δx_{P}) indicates a higher silicon ageing (ϑ_{Si}).

18. The method according to claim 17, wherein to determine the graphite ageing (ϑ_{Gr}), a graphite-related height (x_{P,Gr}) of the discharge plateau (4) is ascertained and a decreasing graphite-related height (x_{P,Gr}) indicates a higher graphite ageing (ϑ_{Gr}).

19. The method according to claim 17, wherein with known silicon ageing (ϑ_{Si}) and graphite ageing (ϑ_{Gr}), a respective maxima (x_{M}) of the cell thickness change (x), which are caused by silicon (Si) and graphite (Gr), are ascertained at full charge, such that a minimum (x_{M,NMC}) of the cell thickness change (x) occurring at full charge is ascertained by NMC from a difference between a total maxima and a Gr- and Si-related maximum (x_{M}), wherein increasing NMC ageing (ϑ_{NMC}) is concluded with a decreasing absolute value of the minimum (x_{M,NMC}).
